(19) United States
(12) Patent Application Publication
(10) Pub. No.: US 2026/0254996 A1
(43) Pub. Date: Aug. 27, 2026

(54) ENHANCED IMAGE SLICE RECONSTRUCTION FOR VIDEO STREAMS

(71) Applicant: Intel Corporation, Santa Clara, CA (US)

(72) Inventors: Yi Wang, Shanghai (CN); Jianxin Du, Shanghai (CN); Ping Yu, Shanghai (CN); Xiaomin Chen, Shanghai (CN); Ming Li, Shanghai (CN); Raul Diaz, Palo Alto, CA (US); Tahani Trigui, Vancouver (CA)

(73) Assignee: Intel Corporation, Santa Clara, CA (US)

(21) Appl. No.: 18/995,345

(22) PCT Filed: Sep. 29, 2022
(86) PCT No.: PCT/CN2022/122800

§ 371 Date: Jan. 16, 2025

(51) Int. Cl. H04N 19/63; H04N 19/157; H04N 19/167; H04N 19/174; H04N 19/70

(52) U.S. Cl. CPC H04N 19/63; H04N 19/157; H04N 19/167; H04N 19/174; H04N 19/70

(57) ABSTRACT

This disclosure describes systems, methods, and devices related to decoding JPEG XS video data. A device may identify a bitstream received from a device, the bitstream encoded using JPEG XS; determine that a first slice of a video frame of the bitstream is located within a region of interest of the video frame; determine that a second slice of the video frame is not located within a region of interest of the video frame; discard the second slice based on the determination that the second slice is not located within a region of interest of the video frame; apply an inverse wavelet transformation to the first slice based on the determination that the first slice is located within a region of interest of the video frame; and generate a reconstructed video frame including the first slice and excluding the second slice.

### TECHNICAL FIELD

This disclosure generally relates to systems and methods for video slice reconstruction and, more particularly, to independent image slice reconstruction of a JPEG XS-based video streams.

### BACKGROUND

JPEG XS is a low-latency, lightweight image codec. Compared to an uncompressed video use case, JPEG XS allows higher resolutions and video frame rates while offering visually lossless quality, reduced power consumption, and a minimal end-to-end latency.

### BRIEF DESCRIPTION OF THE DRAWINGS

FIG. 1 illustrates example processes for JPEG XS encoding, according to some example embodiments of the present disclosure.

FIG. 2 illustrates an example process for slice-level JPEG XS decoding, according to some example embodiments of the present disclosure.

FIG. 3 is an example block diagram of a JPEG XS encoder and decoder, according to some example embodiments of the present disclosure.

FIG. 4 illustrates a flow diagram of an illustrative process for slice-level JPEG XS decoding, in accordance with one or more example embodiments of the present disclosure.

FIG. 5 illustrates an embodiment of an exemplary system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

In the media production industry, low latency and reliability is crucial for media transmission. With the development and application of video ultra-high-definition technology, the traditional universal SDI technology architecture is becoming difficult to adapt. Transformation from SDI to IP technology is the industry trend. SMPTE (Society of Motion Picture and Television Engineers) has published a set of digital video transmission standards, that is, ST2110 standards suite, and ST2110-22 is part of the standards. The JPEG XS codec specification is widely used in ST2110-22 streaming.

In a consumer unit (e.g., decoder side) of ST2110-22, different devices may have different capabilities. For example, some may have specific unit (like a field-programmable gate array) to process the JPEG XS stream, while some may have a more generic compute unit (e.g., CPU). For the use cases of virtual reality (VR) and Video Realtime Edit, only part of the image in the viewpoint may need to be disposed. However, the current JPEG XS codec supports only frame-level wavelet transformation, which means that the consumer has to detect all the slices of one JPEG XS frame, decode and reconstruct the entire frame (e.g., all the slices of the frame), and then output the ROI (Region Of Interest). For example, in JPEG XS, a JPEG XS bitstream is received by the decoder, which parses packets, decodes bitplane counts (e.g., amplitude levels of groups of neighboring wavelet coefficients belonging to a same sub-band), performs data dequantization, performs an inverse discrete wavelet transformation, and then performs multi-component transform to reconstruct an output image (e.g., video frame). The JPEG XS encoder and decoder structure and functionality are described further herein.

In low-latency applications, it may be more efficient to reconstruct only the frame slices that are part of the frames ROIs.

In the current JPEG XS specification, wavelet transformation runs across slice boundaries. Inverse wavelet transformation is the final stage of decoder, as a result, for ST2110-22 consumers, to extract the ROI, the consumer device may have to gather all the slices of the JPEG XS frame, then decode and reconstruct the entire frame (e.g., including slices that are not part of the ROIs). Some of the reconstructed region may not be valuable when not part of the ROI, and therefore may be discarded, resulting in a waste of computational resources and an increase in the latency, which is very important in the video production industry, among other industries/applications.

There is therefore a need for an enhanced image slice reconstruction of JPEG XS-based video streams.

In one or more embodiments, to increase density and decrease latency in the consumer unit, especially for high-definition (HD) resolution, the present disclosure provides a method for independent slice reconstruction. The independent slice reconstruction represents an enhancement to the JPEG XS codec, allowing for only ROI-covered-slices to be reconstructed rather than reconstructing an entire frame and then discarding non-ROI portions. The enhancement may be implemented in a field-programmable gate array (FPGA) and/or graphics processing unit (GPU).

Currently, the Fslc indicator (e.g., slice coding mode) in a picture header has a value of only zero, indicating that the wavelet transformation runs across slice boundaries). In one or more embodiments, a new value for Fslc may be 1 to indicate the mode in which a wavelet transformation runs per slice rather than across slice boundary. On the producer side, the JPEG XS encoder runs wavelet transformation per slice when the Fslc is set to 1, benefiting encoding parallelism for the wavelet transformation stage. On the consumer side, an application may control the region of the image to address, and the JPEG XS decoder may calculate the ROI-covered slices of the image based on the slice height information in the picture header. The decoder may address a real-time transport protocol (RTP) packet with an ROI-covered slice identifier when Fslc is 1, and may reconstruct the corresponding slice, crop, and scale to generate the ROI.

In one or more embodiments, the enhanced independent slice reconstruction allows JPEG XS more usable for virtual reality and Video Realtime Edit without increasing encoding complexity or latency.

In one or more embodiments, on the consumer side, when the decoder receives a ST2110-22 RTP packet, RFC9134 (e.g., the RTP payload format used for video encoded using JPE XS) may be used for the JPEG XS stream RTP packetization. There are two different packetization modes defined for this RTP payload format, codestream packetization mode and slice packetization mode. In the slice packetization mode, the payload header contains the slice id (e.g., SEP counter) information. If the Fslc in picture header equals to 1, which means the wavelet transformation per slice mode is enabled, the decoder will only parse and decode the rtp payload if the slice id is in the range of ROI-covered slices, reconstruct the ROI-covered slices, then get the ROI output. Non-ROI slices may be discarded.

In one or more embodiments, for artifacts identified at slice boundaries, if the encoder and decoder follow the same principle that a wavelet must not cross the slice boundary, no artifacts are generated. This is similar to how intra prediction may not cross the slice boundary in H264. Currently, JPEG XS utilizes wavelet filtering with a 5-3 filter. There is an extend_samples syntax in the JPEG XS standard to account for the picture boundary before applying an inverse wavelet filter per picture level. The same logic may be applied in the slice boundary, so that the slice independent reconstruction is fulfilled without artifacts. When wavelet transformation per slice is enabled in encoder side, the decode inverse_transformation could be changed by adding per-slice coding as shown below in Table 1.

TABLE 1
Proposed JPEG XS Bitstream Syntax Change
for Inverse Transformation on Decoder Side:
Syntax

inverse_transformation( ){
for(slice = 0; slice < total_slice; slice++){
for(k=0; k<N_{c};k=k+1){
reorder_coefficients(k)
Dₓ=min(N_{L,x};dₓ > Dₓ; dₓ = dₓ−1){
hor_transform(k,LL_{dx-1,NLy}, HL_{dx,NLy})
}
for(d=Dₓ;d>0;d=d−1){
hor_transform(k,LL_{d-1,d}, LL_{d,d}, HL_{d,d})
hor_transform(k,LH_{d-1,d}, LH_{d,d}, HH_{d,d})
ver_transform(k,LL_{d-1,d-1}LL_{d-1,d}LH_{d-1,d})
}
assign_slice_output(slice, k, LL_{0,0})
} //end of component level inverse transformation
} // end of slice level inverse transformation
} // end of picture inverse transformation

The “for (slice=0; slice <total_slice; slice++)” and “assign_slice_output (slice, k, LL_{0,0})” of Table 1 may be added to the existing syntax for the slice level inverse transformation.

In one or more embodiments, the decoder may identify slices of a video frame encoded using JPEG XS. The decoder may determine for each slice (e.g., based on a slice identifier for each slice) if a given slice is within a range of slices identified in the bitstream syntax as being part of the ROI-covered slices. The decoder may discard non-ROI-covered slices, and for ROI-covered slices, may perform bitplane count decoding, data dequantization, inverse wavelet transformation, and inverse multi-component transform. Based on the reconstructed slices of the video frame, which may be less than the entire encoded frame, the decoder may crop the reconstructed ROI slices and scale the resulting image to the desired resolution.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

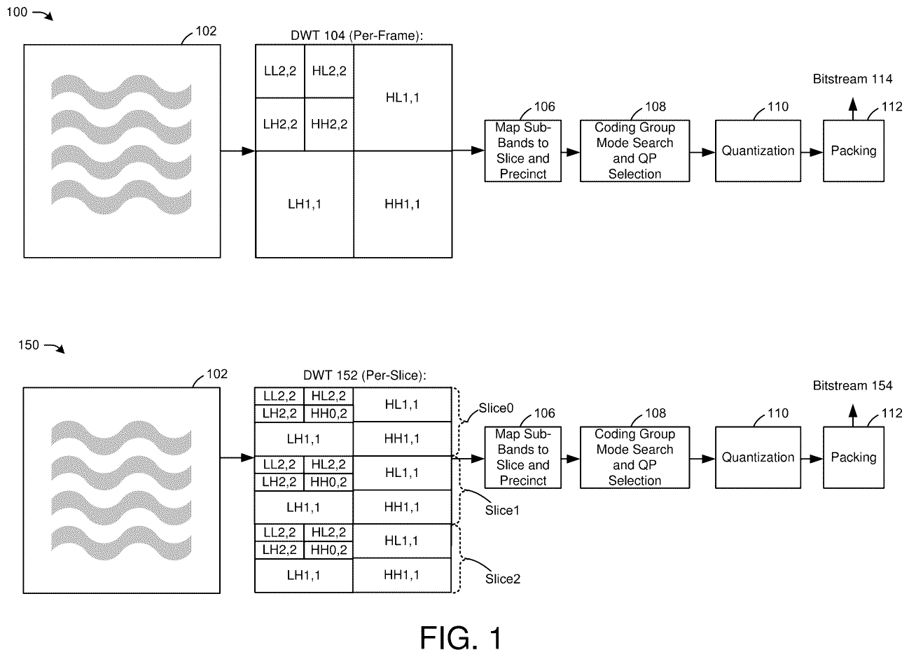

FIG. 1 illustrates example processes for JPEG XS encoding, according to some example embodiments of the present disclosure.

Referring to FIG. 1, a JPEG XS encoding process 100 may include an input image 102 (e.g., video frame) on which a discrete wavelet transform (DWT) 104 is performed on a per-frame level. The DWT 104 may decompose the input image 102 into sub-bands (e.g., LL, LH, HL, HH) whose frequency components cover the full frequency spectrum of the input image 102. A LL (low-low) sub-band may represent an approximate image of the input image 102 in a low-frequency horizontal features and low-frequency vertical features, and may be further decomposed. A LH (low-high) sub-band may be used to extract low-frequency vertical features and high-frequency horizontal features of the input image 102. A HL (high-low) sub-band may be used to extract high-frequency vertical features and low-frequency horizontal features of the input image 102. A HH (high-high) sub-band may be used to extract high-frequency vertical features and high-frequency horizontal features of the input image 102. Each of the sub-bands may represent a sub-image of the input image 102 and wavelet coefficients. At step 106, the JPEG XS encoding process 100 may include mapping the sub-bands of the input image 102 to a slice and to the slice precincts (e.g., the wavelet coefficients for a respective slice). At step 108, the JPEG XS encoding process 100 may include a coding group mode search and QP selection. At step 110, the JPEG XS encoding process 100 may include quantization using the QPs. At step 112, the JPEG XS encoding process 100 may include packing the quantized wavelet coefficients into a bitstream 114.

Still referring to FIG. 1, a JPEG XS encoding process 150 may include the input image 102 (e.g., video frame) on which a discrete wavelet transform (DWT) 152 is performed on a per-slice level (e.g., slice0, slice1, slice2). The DWT 152 may decompose the input image 102 into sub-bands (e.g., LL, LH, HL, HH) based on slice level whose frequency components cover the full frequency spectrum of each slice of the input image 102. A LL (low-low) sub-band may represent an approximate image of the corresponding slice in a low-frequency horizontal features and low-frequency vertical features, and may be further decomposed. A LH (low-high) sub-band may be used to extract low-frequency vertical features and high-frequency horizontal features of the corresponding slice. A HL (high-low) sub-band may be used to extract high-frequency vertical features and low-frequency horizontal features of the corresponding slice. A HH (high-high) sub-band may be used to extract high-frequency vertical features and high-frequency horizontal features of the corresponding slice. Each of the sub-bands may represent a sub-image of the slice and wavelet coefficients. At step 106, the JPEG XS encoding process 150 may include mapping the sub-bands of the input image 102 to a slice and to the slice precincts (e.g., the wavelet coefficients for a respective slice). At step 158, the JPEG XS encoding process 100 may include a coding group mode search and QP selection. At step 110, the JPEG XS encoding process 150 may include quantization using the QPs. At step 112, the JPEG XS encoding process 150 may include packing the quantized wavelet coefficients into a bitstream 154.

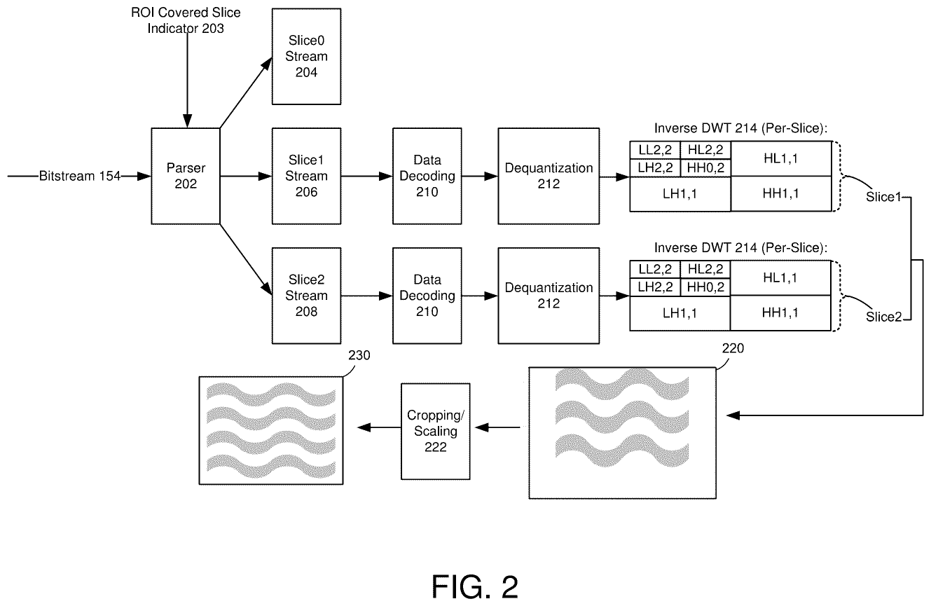

FIG. 2 illustrates an example process 200 for slice-level JPEG XS decoding, according to some example embodiments of the present disclosure.

Referring to FIG. 2, the bitstream 154 of FIG. 1 is received. Because the bitstream 154 is encoded using the DWT 152 on a per-slice level, the slice reconstruction may be independent as shown in FIG. 2 and explained further herein. A parser 202 may receive (e.g., from an application using the bitstream 154 and configured to detect ROIs) an indication 203 of which slices are ROI-covered slices. The parser 202 may identify the slices of a given video frame of the bitstream 154 (e.g., slice0, slice1, slice2 of the input image 102 of FIG. 1), and may generate streams for each slice (e.g., slice0 stream 204, slice1 stream 206, slice2 stream 208). The parser 202 may identify which slices of a frame are ROI-covered slices, and may discard slices of the frame which are not ROI-covered slices (e.g., may discard the slice0 stream 204). The slice1 stream 206 may be decoded at step 210 and dequantized at step 212. The process 200 may perform an inverse DWT 214 (e.g., per-slice) to generate the wavelet coefficients per sub-band of slice1. Similarly, the process 200 may decode the slice2 stream 208 at step 210, and may dequantize the slice2 stream 208 at step 212. Applying the inverse DWT 214, the process 200 may generate the wavelet coefficients per sub-band of slice2. Reconstructed slice1 and slice2 may be combined to generate image 220 (e.g., representing a portion of the input image 102, as the image 220 includes slice1 and slice2, but no slice0). The process 200 may include cropping and scaling the image 220 at step 222 to generate image 230 (e.g., a reconstructed video frame for playback).

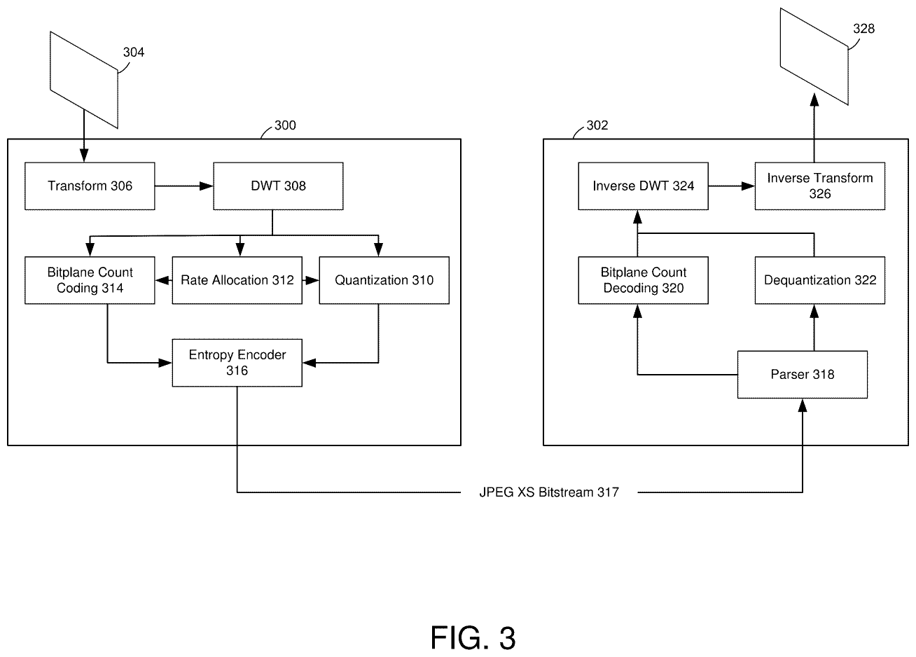

FIG. 3 is an example block diagram of a JPEG XS encoder 300 and decoder 302, according to some example embodiments of the present disclosure.

Referring to FIG. 3, the JPEG XS encoder 300 may receive an input image 304 (e.g., video frame). An optional color transform 306 may be followed by a discrete wavelet transform (DWT) 308. The DWT 308 may apply horizontal and vertical decompositions (e.g., using a 5-3 filter) with one or more vertical DWT decompositions and multiple horizontal decompositions to reduce dimensionality of the input image 304. In particular, the DWT 308 may decompose the input image 304 into sub-bands (e.g., LL, LH, HL, HH) whose frequency components cover the full frequency spectrum of the input image 304. A LL (low-low) sub-band may represent an approximate image of the input image 304 in a low-frequency horizontal features and low-frequency vertical features, and may be further decomposed. A LH (low-high) sub-band may be used to extract low-frequency vertical features and high-frequency horizontal features of the input image 304. A HL (high-low) sub-band may be used to extract high-frequency vertical features and low-frequency horizontal features of the input image 304. A HH (high-high) sub-band may be used to extract high-frequency vertical features and high-frequency horizontal feature of the input image 304. Each of the sub-bands may represent a sub-image of the input image 304 and wavelet coefficients. A quantization module 310 removes the least significant bits of the wavelet coefficients based on a rate control provided by a rate allocation module 312 to meet a target bitrate. Neighboring wavelet coefficients belonging to a same sub-band may be grouped into bitplane counts by a bitplane count coding module 314. The coded bitplane counts and quantized wavelet coefficients may be packed by the entropy encoder 316 to generate a JPEG XS bitstream 317.

Still referring to FIG. 3, the decoder 302 may parse the JPEG XS bitstream 317 with a parser 318. Bitplane counts of the parsed packets of the JPEG XS bitstream 317 may be decoded by a bitplane count decoding module 320, and the quantized wavelet coefficients may be dequantized by a dequantization module 322. The neighboring wavelet coefficients belonging to a same sub-band and the dequantized wavelet coefficients may be inversely transformed by an inverse DWT 324. An optional inverse color transform 326 also may be applied to the decoded data. The decoded and inversely transformed wavelets may be used in an output image 328 (e.g., video frame).

When the encoder 300 provides (e.g., in the JPEG XS bitstream 317) an indication of the slices of the video frames of the JPEG XS bitstream 317 that are part of the ROIs, and when the encoder 300 sets the Fslc parameter in the picture header of the JPEG XS bitstream 317 to 1, the decoder 302 may parse and decode the ROI slices of a given video frame and discard the non-ROI slices as shown in FIG. 2.

In one or more embodiments, the JPEG XS encoder 300 and the JPEG XS decoder 302 may be separate physical devices (e.g., the JPEG XS bitstream 317 may be a wireless transmission between the two devices).

It is understood that the above descriptions are for purposes of illustration and are not meant to be limiting.

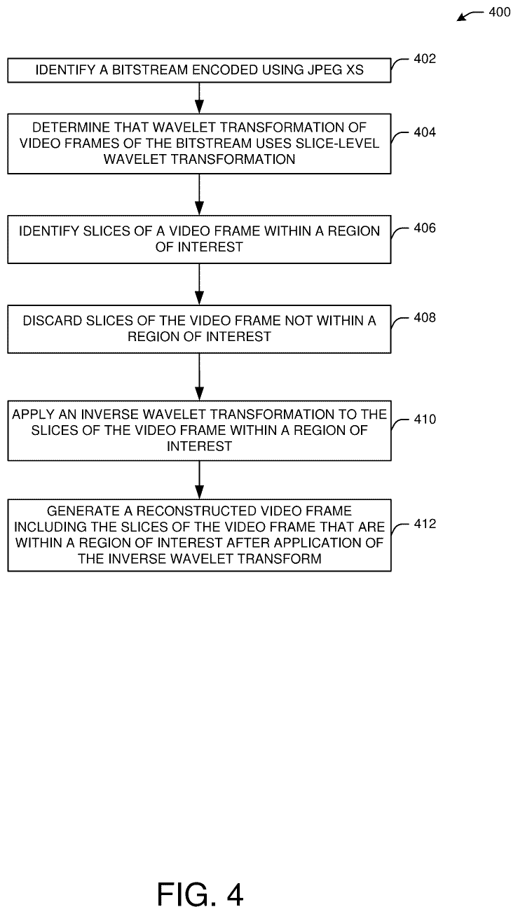

FIG. 4 illustrates a flow diagram of an illustrative process 400 for slice-level JPEG XS decoding, in accordance with one or more example embodiments of the present disclosure.

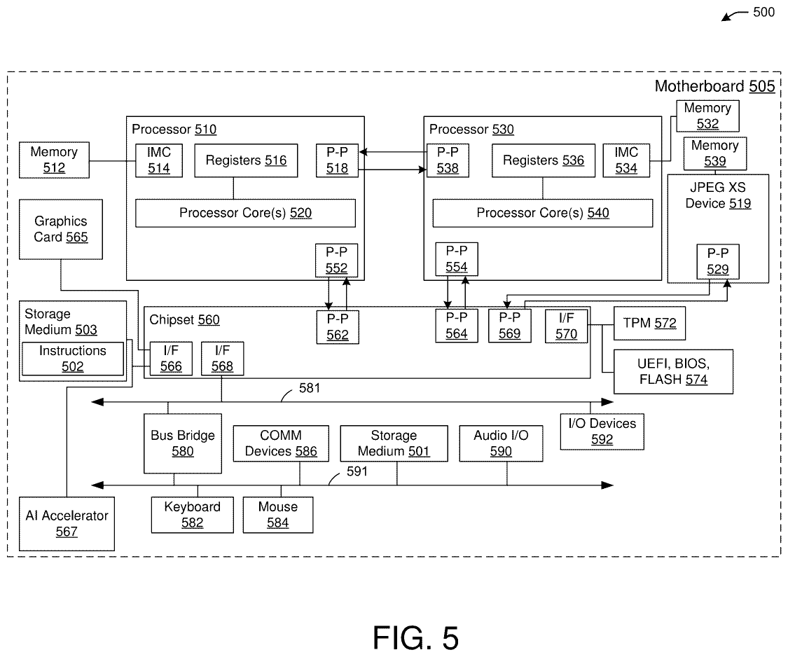

At block 402, a device (e.g., the JPEG XS decoder 302 of FIG. 3, the graphics card 565 of FIG. 5, the JPEG XS device 519 of FIG. 5) may identify a bitstream received from another device, the bitstream encoded using JPEG XS (e.g., the bitstream 154 of FIG. 1, the JPEG XS bitstream 317 of FIG. 3).

At block 404, the device may determine that the wavelet transformation of video streams in the bitstream uses slice-level wavelet transformation. For example, the Fslc indicator may be set to 1 to indicate the mode in which a wavelet transformation runs per slice rather than across slice boundary.

At block 406, the device may identify slices in a given video frame within a region of interest. At block 408, the device may identify and discard slices in a given video frame not within a region of interest. The region of interest may be determined by an application using the bitstream, and indicated to the device. The bitstream may include slice indicators for any slice, and when a slice's slice indicator is included in a list of ROI-covered slices, the device may identify the ROI slices and non-ROI slices.

At block 410, the device may apply an inverse wavelet transform (e.g., the inverse DWT 324 of FIG. 3) to the slices whose slice identifiers are included in the ROI-covered slices. The inverse wavelet transform may recover the wavelet coefficients for the respective ROI slices of a frame. The inverse wavelet transform may reconstruct wavelet data based on quantized wavelet coefficients in the bitstream.

At block 412, the device may generate a reconstructed video frames including the ROI-covered slices and excluding the non-ROI slices. The ROI slices may be fewer than the total number of slices of a video frame, so the ROI slices may be cropped and/or scaled (e.g., increasing the scale to meet a resolution of the video frame) to expand the subset of slices to the desired video frame resolution. The reconstructed video frame may be presented for playback.

It is understood that the above descriptions are for purposes of illustration and are not meant to be limiting.

FIG. 5 illustrates an embodiment of an exemplary system 500, in accordance with one or more example embodiments of the present disclosure.

In various embodiments, the computing system 500 may comprise or be implemented as part of an electronic device.

In some embodiments, the computing system 500 may be representative, for example, of a computer system that implements one or more components of FIGS. 1-3.

The embodiments are not limited in this context. More generally, the computing system 500 is configured to implement all logic, systems, processes, logic flows, methods, equations, apparatuses, and functionality described herein and with reference to FIGS. 1-3.

The system 500 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 500 may have a single processor with one core or more than one processor. Note that the term “processor” refers to a processor with a single core or a processor package with multiple processor cores.

In at least one embodiment, the computing system 500 is representative of one or more components of FIGS. 1-3. More generally, the computing system 500 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 500. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 500 comprises a motherboard 505 for mounting platform components. The motherboard 505 is a point-to-point interconnect platform that includes a processor 510, a processor 530 coupled via a point-to-point interconnects as an Ultra Path Interconnect (UPI), and a JPEG XS device 519 (e.g., capable of performing the functions of FIGS. 1-4). In other embodiments, the system 500 may be of another bus architecture, such as a multi-drop bus. Furthermore, each of processors 510 and 530 may be processor packages with multiple processor cores. As an example, processors 510 and 530 are shown to include processor core(s) 520 and 540, respectively. While the system 500 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 510 and the chipset 560. Some platforms may include additional components and some platforms may only include sockets to mount the processors and/or the chipset.

The processors 510 and 530 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 510, and 530.

The processor 510 includes an integrated memory controller (IMC) 514 and point-to-point (P-P) interfaces 518 and 552. Similarly, the processor 530 includes an IMC 534 and P-P interfaces 538 and 554. The IMC's 514 and 534 couple the processors 510 and 530, respectively, to respective memories, a memory 512 and a memory 532. The memories 512 and 532 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 512 and 532 locally attach to the respective processors 510 and 530.

In addition to the processors 510 and 530, the system 500 may include the JPEG XS device 519. The JPEG XS device 519 may be connected to chipset 560 by means of P-P interfaces 529 and 569. The JPEG XS device 519 may also be connected to a memory 539. In some embodiments, the JPEG XS device 519 may be connected to at least one of the processors 510 and 530. In other embodiments, the memories 512, 532, and 539 may couple with the processor 510 and 530, and the JPEG XS device 519 via a bus and shared memory hub.

System 500 includes chipset 560 coupled to processors 510 and 530. Furthermore, chipset 560 can be coupled to storage medium 503, for example, via an interface (I/F) 566. The I/F 566 may be, for example, a Peripheral Component Interconnect-enhanced (PCI-e). The processors 510, 530, and the JPEG XS device 519 may access the storage medium 503 through chipset 560.

Storage medium 503 may comprise any non-transitory computer-readable storage medium or machine-readable storage medium, such as an optical, magnetic or semiconductor storage medium. In various embodiments, storage medium 503 may comprise an article of manufacture. In some embodiments, storage medium 503 may store computer-executable instructions, such as computer-executable instructions 502 to implement one or more of processes or operations described herein, (e.g., process 400 of FIG. 4). The storage medium 503 may store computer-executable instructions for any equations depicted above. The storage medium 503 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 510 couples to a chipset 560 via P-P interfaces 552 and 562 and the processor 530 couples to a chipset 560 via P-P interfaces 554 and 564. Direct Media Interfaces (DMIs) may couple the P-P interfaces 552 and 562 and the P-P interfaces 554 and 564, respectively. The DMI may be a high-speed interconnect that facilitates, e.g., eight Giga Transfers per second (GT/s) such as DMI 3.0. In other embodiments, the processors 510 and 530 may interconnect via a bus.

The chipset 560 may comprise a controller hub such as a platform controller hub (PCH). The chipset 560 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 560 may comprise more than one controller hub such as a chipset with a memory controller hub, a graphics controller hub, and an input/output (I/O) controller hub.

In the present embodiment, the chipset 560 couples with a trusted platform module (TPM) 572 and the UEFI, BIOS, Flash component 574 via an interface (I/F) 570. The TPM 572 is a dedicated microcontroller designed to secure hardware by integrating cryptographic keys into devices. The UEFI, BIOS, Flash component 574 may provide pre-boot code.

Furthermore, chipset 560 includes the I/F 866 to couple chipset 560 with a high-performance graphics engine, graphics card 565. In other embodiments, the system 500 may include a flexible display interface (FDI) between the processors 510 and 530 and the chipset 560. The FDI interconnects a graphics processor core in a processor with the chipset 560.

Various I/O devices 592 couple to the bus 581, along with a bus bridge 580 which couples the bus 581 to a second bus 591 and an I/F 868 that connects the bus 581 with the chipset 560. In one embodiment, the second bus 591 may be a low pin count (LPC) bus. Various devices may couple to the second bus 591 including, for example, a keyboard 582, a mouse 584, communication devices 586, a storage medium 501, and an audio I/O 590.

The artificial intelligence (AI) accelerator 567 may be circuitry arranged to perform computations related to AI. The AI accelerator 567 may be connected to storage medium 503 and chipset 560. The AI accelerator 567 may deliver the processing power and energy efficiency needed to enable abundant-data computing. The AI accelerator 567 is a class of specialized hardware accelerators or computer systems designed to accelerate artificial intelligence and machine learning applications, including artificial neural networks and machine vision. The AI accelerator 567 may be applicable to algorithms for robotics, internet of things, other data-intensive and/or sensor-driven tasks.

Many of the I/O devices 592, communication devices 586, and the storage medium 501 may reside on the motherboard 505 while the keyboard 582 and the mouse 584 may be add-on peripherals. In other embodiments, some or all the I/O devices 592, communication devices 586, and the storage medium 501 are add-on peripherals and do not reside on the motherboard 505.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions that, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. Integrated circuits, processor packages, chip packages, and chipsets may comprise one or more processors.

Processors may receive signals such as instructions and/or data at the input(s) and process the signals to generate at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include an apparatus for decoding video data encoded using JPEG XS, the apparatus comprising processing circuitry coupled to memory, the processing circuitry configured to: identify a bitstream received from a device, the bitstream encoded using JPEG XS; determine that a first slice of a video frame of the bitstream is located within a region of interest of the video frame; determine that a second slice of the video frame is not located within a region of interest of the video frame; discard the second slice based on the determination that the second slice is not located within a region of interest of the video frame; apply an inverse wavelet transformation to the first slice based on the determination that the first slice is located within a region of interest of the video frame; and generate a reconstructed video frame comprising the first slice after the application of the inverse wavelet transformation to the first slice, wherein the second slice is absent from the reconstructed video frame.

Example 2 may include the apparatus of example 1 and/or any other example herein, wherein the processing circuitry is further configured to: identify a slice coding mode indicator in a picture header of the bitstream; and determine that the slice coding mode indicator has a value of 1 indicating that wavelet transformation is per-slice and not across slice boundaries.

Example 3 may include the apparatus of example 2 and/or any other example herein, wherein to apply the inverse wavelet transformation to the first slice is further based on the determination that the slice coding mode indicator has the value of 1 indicating that wavelet transformation is per-slice and not across slice boundaries.

Example 4 may include the apparatus of example 2 or example 3, wherein the processing circuitry is further configured to: identify a slice identifier of the first slice in a payload header of the bitstream; and determine, based on the determination that the slice coding mode indicator has the value of 1 indicating that wavelet transformation is per-slice and not across slice boundaries, that the slice identifier is included within a range of region of interest-covered slices of the video frame, wherein to apply the inverse wavelet transformation to the first slice is further based on the determination that the slice identifier is included within the range of region of interest-covered slices of the video frame.

Example 5 may include the apparatus of example 2 or example 3, wherein the processing circuitry is further configured to: identify a slice identifier of the second slice in a payload header of the bitstream; and determine, based on the determination that the slice coding mode indicator has the value of 1 indicating that wavelet transformation is per-slice and not across slice boundaries, that the slice identifier is not within a range of region of interest-covered slices of the video frame, wherein to discard the second slice is further based on the determination that the slice identifier is not within the range of region of interest-covered slices of the video frame.

Example 6 may include the apparatus of example 1, and/or any other example herein, wherein the processing circuitry is further configured to: determine that a third slice of the video frame is located within a region of interest of the video frame; and apply the inverse wavelet transformation to the third slice based on the determination that the third slice is located within a region of interest of the video frame, wherein the reconstructed video frame further comprises the third slice after the application of the inverse wavelet transformation to the third slice.

Example 7 may include the apparatus of example 6, wherein to generate the reconstructed video frame further comprises to crop the first slice and the third slice.

Example 8 may include the apparatus of example 6, wherein to generate the reconstructed video frame further comprises to increase a scale of the first slice and the third slice.

Example 9 may include the apparatus of example 1, wherein the inverse wavelet transformation is unapplied to the second slice based on the determination that the second slice is not located within a region of interest of the video frame.

Example 10 may include a computer-readable storage medium comprising instructions to cause processing circuitry of a device for decoding video data encoded using JPEG XS, upon execution of the instructions by the processing circuitry, to: identify a bitstream received from a second device, the bitstream encoded using JPEG XS; determine that a first slice of a video frame of the bitstream is located within a region of interest of the video frame; determine that a second slice of the video frame is not located within a region of interest of the video frame; discard the second slice based on the determination that the second slice is not located within a region of interest of the video frame; apply an inverse wavelet transformation to the first slice based on the determination that the first slice is located within a region of interest of the video frame; and generate a reconstructed video frame comprising the first slice after the application of the inverse wavelet transformation to the first slice, wherein the second slice is absent from the reconstructed video frame.

Example 11 may include the computer-readable medium of example 10 and/or any other example herein, wherein execution of the instructions further causes the processing circuitry to: identify a slice coding mode indicator in a picture header of the bitstream; determine that the slice coding mode indicator has a value of 1 indicating that wavelet transformation is per-slice and not across slice boundaries.

Example 12 may include the computer-readable medium of example 11 and/or any other example herein, wherein to apply the inverse wavelet transformation to the first slice is further based on the determination that the slice coding mode indicator has the value of 1 indicating that wavelet transformation is per-slice and not across slice boundaries.

Example 13 may include the computer-readable medium of example 11 or example 12, and/or any other example herein wherein execution of the instructions further causes the processing circuitry to: identify a slice identifier of the first slice in a payload header of the bitstream; and determine, based on the determination that the slice coding mode indicator has the value of 1 indicating that wavelet transformation is per-slice and not across slice boundaries, that the slice identifier is included within a range of region of interest-covered slices of the video frame, wherein to apply the inverse wavelet transformation to the first slice is further based on the determination that the slice identifier is included within the range of region of interest-covered slices of the video frame.

Example 14 may include the computer-readable medium of example 11 or example 12, wherein execution of the instructions further causes the processing circuitry to: identify a slice identifier of the second slice in a payload header of the bitstream; and determine, based on the determination that the slice coding mode indicator has the value of 1 indicating that wavelet transformation is per-slice and not across slice boundaries, that the slice identifier is not within a range of region of interest-covered slices of the video frame, wherein to discard the second slice is further based on the determination that the slice identifier is not within the range of region of interest-covered slices of the video frame.

Example 15 may include the computer-readable medium of example 10, wherein execution of the instructions further causes the processing circuitry to: determine that a third slice of the video frame is located within a region of interest of the video frame; and apply the inverse wavelet transformation to the third slice based on the determination that the third slice is located within a region of interest of the video frame, wherein the reconstructed video frame further comprises the third slice after the application of the inverse wavelet transformation to the third slice.

Example 16 may include the computer-readable medium of example 15, wherein to generate the reconstructed video frame further comprises to crop the first slice and the third slice.

Example 17 may include the computer-readable medium of example 15, wherein to generate the reconstructed video frame further comprises to increase a scale of the first slice and the third slice.

Example 18 may include the computer-readable medium of example 10, wherein the inverse wavelet transformation is unapplied to the second slice based on the determination that the second slice is not located within a region of interest of the video frame.

Example 19 may include a method for decoding video data encoded using JPEG XS, the method comprising: identifying, by processing circuitry of a first device, a bitstream received from a second device, the bitstream encoded using JPEG XS; determining, by the processing circuitry, that a first slice of a video frame of the bitstream is located within a region of interest of the video frame; determining, by the processing circuitry, that a second slice of the video frame is not located within a region of interest of the video frame; discarding, by the processing circuitry, the second slice based on the determination that the second slice is not located within a region of interest of the video frame; applying, by the processing circuitry, an inverse wavelet transformation to the first slice based on the determination that the first slice is located within a region of interest of the video frame; and generating, by the processing circuitry, a reconstructed video frame comprising the first slice after the application of the inverse wavelet transformation to the first slice, wherein the second slice is absent from the reconstructed video frame.

Example 20 may include the method of example 19 and/or any other example herein, further comprising: identifying a slice coding mode indicator in a picture header of the bitstream; determining that the slice coding mode indicator has a value of 1 indicating that wavelet transformation is per-slice and not across slice boundaries.

Example 21 may include the method of example 20 and/or any other example herein, wherein to apply the inverse wavelet transformation to the first slice is further based on the determination that the slice coding mode indicator has the value of 1 indicating that wavelet transformation is per-slice and not across slice boundaries.

Example 22 may include the method of example 20 or example 21, and/or any other example herein, further comprising: identifying a slice identifier of the first slice in a payload header of the bitstream; and determining, based on the determination that the slice coding mode indicator has the value of 1 indicating that wavelet transformation is per-slice and not across slice boundaries, that the slice identifier is included within a range of region of interest-covered slices of the video frame, wherein applying the inverse wavelet transformation to the first slice is further based on the determination that the slice identifier is included within the range of region of interest-covered slices of the video frame.

Example 23 may include the method of example 20 or example 21, and/or any other example herein, further comprising: identifying a slice identifier of the second slice in a payload header of the bitstream; and determining, based on the determination that the slice coding mode indicator has the value of 1 indicating that wavelet transformation is per-slice and not across slice boundaries, that the slice identifier is not within a range of region of interest-covered slices of the video frame, wherein discarding the second slice is further based on the determination that the slice identifier is not within the range of region of interest-covered slices of the video frame.

Example 24 may include the method of claim 19 and/or any other example herein, further comprising: determining that a third slice of the video frame is located within a region of interest of the video frame; and applying the inverse wavelet transformation to the third slice based on the determination that the third slice is located within a region of interest of the video frame, wherein the reconstructed video frame further comprises the third slice after the application of the inverse wavelet transformation to the third slice.

Example 25 may include the method of example 24 and/or any other example herein, wherein generating the reconstructed video frame further comprises to crop the first slice and the third slice.

Example 26 may include an apparatus comprising means for: identifying a bitstream received from a second device, the bitstream encoded using JPEG XS; determining that a first slice of a video frame of the bitstream is located within a region of interest of the video frame; determining that a second slice of the video frame is not located within a region of interest of the video frame; discarding the second slice based on the determination that the second slice is not located within a region of interest of the video frame; applying an inverse wavelet transformation to the first slice based on the determination that the first slice is located within a region of interest of the video frame; and generating a reconstructed video frame comprising the first slice after the application of the inverse wavelet transformation to the first slice, wherein the second slice is absent from the reconstructed video frame.

Example 27 may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Example 28 may include an apparatus comprising logic, modules, and/or circuitry to perform one or more elements of a method described in or related to any of examples 1-26, or any other method or process described herein.

Example 29 may include a method, technique, or process as described in or related to any of examples 1-26, or portions or parts thereof.

Example 30 may include an apparatus comprising: one or more processors and one or more computer readable media comprising instructions that, when executed by the one or more processors, cause the one or more processors to perform the method, techniques, or process as described in or related to any of examples 1-26, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1-25. (canceled)

26. An apparatus to decode video data encoded using JPEG XS, the apparatus comprising:
memory;
instructions; and
at least one processor circuit to be programmed based on the instructions to:
identify a bitstream from a device, the bitstream encoded using JPEG XS;
determine that a first slice of a video frame of the bitstream is located within a region of interest of the video frame;
determine that a second slice of the video frame is not located within the region of interest of the video frame;
discard the second slice based on the determination that the second slice is not located within the region of interest of the video frame;
apply an inverse wavelet transformation to the first slice based on the determination that the first slice is located within the region of interest of the video frame; and
generate a reconstructed video frame including the first slice after the application of the inverse wavelet transformation to the first slice, wherein the second slice is absent from the reconstructed video frame.

27. The apparatus of claim 26, wherein the one or more of the at least one processor circuit is to:
identify a slice coding mode indicator in a picture header of the bitstream; and
determine that the slice coding mode indicator has a value indicating that wavelet transformation is per-slice and not across slice boundaries.

28. The apparatus of claim 27, wherein one or more of the at least one processor circuit is to apply the inverse wavelet transformation to the first slice based on the determination that the slice coding mode indicator has the value indicating that wavelet transformation is per-slice and not across slice boundaries.

29. The apparatus of claim 27, wherein one or more of the at least one processor circuit is to:
identify a slice identifier of the first slice in a payload header of the bitstream;
determine, based on the determination that the slice coding mode indicator has the value indicating that wavelet transformation is per-slice and not across slice boundaries, that the slice identifier is included within a range of region of interest-covered slices of the video frame; and
apply the inverse wavelet transformation to the first slice based on the determination that the slice identifier is included within the range of region of interest-covered slices of the video frame.

30. The apparatus of claim 27, wherein one or more of the at least one processor circuit is to:
identify a slice identifier of the second slice in a payload header of the bitstream;
determine, based on the determination that the slice coding mode indicator has the value indicating that wavelet transformation is per-slice and not across slice boundaries, that the slice identifier is not within a range of region of interest-covered slices of the video frame; and
discard the second slice based on the determination that the slice identifier is not within the range of region of interest-covered slices of the video frame.

31. The apparatus of claim 26, wherein one or more of the at least one processor circuit is to:
determine that a third slice of the video frame is located within the region of interest of the video frame; and
apply the inverse wavelet transformation to the third slice based on the determination that the third slice is located within a region of interest of the video frame,
wherein the reconstructed video frame includes the third slice after the application of the inverse wavelet transformation to the third slice.

32. The apparatus of claim 31, wherein one or more of the at least one processor circuit is to crop the first slice and the third slice to generate the reconstructed video frame.

33. The apparatus of claim 31, wherein one or more of the at least one processor circuit is to increase a scale of the first slice and the third slice to generate the reconstructed video frame.

34. The apparatus of claim 26, wherein one or more of the at least one processor circuit is not to apply the inverse wavelet transformation to the second slice based on the determination that the second slice is not located within the region of interest of the video frame.

35. A non-transitory computer-readable storage medium comprising instructions to cause at least one processor circuit to at least:
identify a bitstream from a second device, the bitstream encoded using JPEG XS;
determine that a first slice of a video frame of the bitstream is located within a region of interest of the video frame;
determine that a second slice of the video frame is not located within the region of interest of the video frame;
discard the second slice based on the determination that the second slice is not located within the region of interest of the video frame;
apply an inverse wavelet transformation to the first slice based on the determination that the first slice is located within the region of interest of the video frame; and
generate a reconstructed video frame including the first slice after the application of the inverse wavelet transformation to the first slice, wherein the second slice is absent from the reconstructed video frame.

36. The computer-readable medium of claim 35, wherein the instructions are to cause one or more of the at least one processor circuit to:
identify a slice coding mode indicator in a picture header of the bitstream; and
determine that the slice coding mode indicator has a value indicating that wavelet transformation is per-slice and not across slice boundaries.

37. The computer-readable medium of claim 36, wherein the instructions are to cause one or more of the at least one processor circuit to apply the inverse wavelet transformation to the first slice based on the determination that the slice coding mode indicator has the value indicating that wavelet transformation is per-slice and not across slice boundaries.

38. The computer-readable medium of claim 36, wherein the instructions are to cause one or more of the at least one processor circuit to:
identify a slice identifier of the first slice in a payload header of the bitstream;
determine, based on the determination that the slice coding mode indicator has the value indicating that wavelet transformation is per-slice and not across slice boundaries, that the slice identifier is included within a range of region of interest-covered slices of the video frame; and
apply the inverse wavelet transformation to the first slice based on the determination that the slice identifier is included within the range of region of interest-covered slices of the video frame.

39. The computer-readable medium of claim 36, wherein the instructions are to cause one or more of the at least one processor circuit to:
identify a slice identifier of the second slice in a payload header of the bitstream;
determine, based on the determination that the slice coding mode indicator has the value indicating that wavelet transformation is per-slice and not across slice boundaries, that the slice identifier is not within a range of region of interest-covered slices of the video frame; and
discard the second slice based on the determination that the slice identifier is not within the range of region of interest-covered slices of the video frame.

40. The computer-readable medium of claim 35, wherein the instructions are to cause one or more of the at least one processor circuit to:
determine that a third slice of the video frame is located within the region of interest of the video frame; and
apply the inverse wavelet transformation to the third slice based on the determination that the third slice is located within the region of interest of the video frame,
wherein the reconstructed video frame further includes the third slice after the application of the inverse wavelet transformation to the third slice.

41. A method to decode video data encoded using JPEG XS, the method including:
identifying, by at least one processor circuit of a first device, a bitstream received from a second device, the bitstream encoded using JPEG XS;
determining, by one or more of the at least one processor circuit, that a first slice of a video frame of the bitstream is located within a region of interest of the video frame;
determining, by one or more of the at least one processor circuit, that a second slice of the video frame is not located within the region of interest of the video frame;
discarding, by one or more of the at least one processor circuit, the second slice based on the determination that the second slice is not located within the region of interest of the video frame;
applying, by one or more of the at least one processor circuit, an inverse wavelet transformation to the first slice based on the determination that the first slice is located within the region of interest of the video frame; and
generating, by one or more of the at least one processor circuit, a reconstructed video frame including the first slice after the application of the inverse wavelet transformation to the first slice, wherein the second slice is absent from the reconstructed video frame.

42. The method of claim 41, including:
identifying a slice coding mode indicator in a picture header of the bitstream; and
determining that the slice coding mode indicator has a value indicating that wavelet transformation is per-slice and not across slice boundaries.

43. The method of claim 42, wherein the applying of the inverse wavelet transformation to the first slice is based on the determination that the slice coding mode indicator has the value indicating that wavelet transformation is per-slice and not across slice boundaries.

44. The method of claim 42, including:
identifying a slice identifier of the first slice in a payload header of the bitstream; and
determining, based on the determination that the slice coding mode indicator has the value indicating that wavelet transformation is per-slice and not across slice boundaries, that the slice identifier is included within a range of region of interest-covered slices of the video frame,
wherein the applying of the inverse wavelet transformation to the first slice is based on the determination that the slice identifier is included within the range of region of interest-covered slices of the video frame.

45. The method of claim 42, including:
identifying a slice identifier of the second slice in a payload header of the bitstream; and
determining, based on the determination that the slice coding mode indicator has the value indicating that wavelet transformation is per-slice and not across slice boundaries, that the slice identifier is not within a range of region of interest-covered slices of the video frame,
wherein the discarding of the second slice is based on the determination that the slice identifier is not within the range of region of interest-covered slices of the video frame.
